(19) United States
(12) Patent Application Publication
(10) Pub. No.: US 2005/0111055 A1
(43) Pub. Date: May 26, 2005

(54) Apparatus and method of image sharpness enhancement

(76) Inventors: Seung-joon Yang, Seoul (KR); Young-jin Kwon, Seoul (KR)

Correspondence Address: STANZIONE & KIM, LLP, 1740 N STREET, N.W., FIRST FLOOR, WASHINGTON, DC, 20036, US

(21) Appl. No.: 10/986,291

(22) Filed: Nov. 12, 2004

(30) Foreign Application Priority Data
Nov. 21, 2003 (KR) 2003-82921

(51) Int. Cl. H04N 1/40; G06K 15/00

(52) U.S. Cl. 358/461; 358/3.03

(57) ABSTRACT

An apparatus and method of image sharpness enhancement. The apparatus includes a slope value calculator to set in an input video signal a window of a predetermined size with reference to a current pixel, and to calculate a slope value based on pixel values within the window, a gain calculator to calculate a gain corresponding to the magnitude of the slope value, a differential value calculator to calculate a differential value which is a difference between pixel values of the current pixel and other pixels within the window, a diffusivity calculator to calculate the diffusivity between the pixels corresponding to the magnitude of the differential value, a diffusivity summer to assign a predetermined weight to the diffusivities between the pixels and to calculate the sum of the diffusivities; and a pixel value converter to multiply the sum of the diffusivities by the gain and to add the multiplied result to the current pixel value. Accordingly, by adaptively applying the weighted diffusivity to the video signal, the image sharpness enhancement is achieved while the visibly objectionable image and the signal distortion are prevented.

### CROSS-REFERENCE TO RELATED APPLICATIONS

This application claims the benefit of Korean Patent Application No. 2003-82921, filed on Nov. 21, 2003, in the Korean Intellectual Property Office, the disclosure of which is incorporated herein by reference.

### BACKGROUND OF THE INVENTION

1. Field of the Invention

The present general inventive concept relates to an apparatus and method of image sharpness enhancement, and more particularly, to an apparatus and method of image sharpness enhancement, which improves a sharpness of an image by adaptively using a weighted diffusivity.

2. Description of the Related Art

An apparatus for image sharpness enhancement operates to obtain a more vivid image quality by improving a sharpness of an image. In the processes of obtaining and transmitting an image, noise may be introduced or image degradation such as blurring may occur. The sharpness of an image can be improved by emphasizing edge components of the details of the image so that quality of a fully-realized image can be improved.

One known technology for image sharpness enhancement is disclosed in U.S. Pat. No. 6,072,538. According to this method, the sharpness enhancement is achieved by subtracting a detail signal determined as a detail component by using a band-pass filter, and by up-sampling and down-sampling the subtracted detail signal. The subtracted detail signal is processed by clipping and crispening, and up-sampled and combined with an original signal. The combined detail signal clips the detail signal to be placed within a predetermined range, and is down-sampled and combined with the original signal, thereby obtaining the sharpness-enhanced signal.

However, the known technology does not adopt a method of combining a detail signal with an original signal at an input signal frequency, but instead combines the signals after increasing a frequency through the up-sampling process. Accordingly, when the detail signal and the original signal are combined with each other, they require a clipping process to be placed within a predetermined luminance range. This consequently causes a distortion in an image signal and a high frequency component which would not exist otherwise, and a viewer experiences a visibly objectionable image. Also, during the down-sampling process, information on the original signal and the detail signal may be lost, which mainly causes the image degradation. It is necessary to prevent the distortion in the signal and objectionable image by reducing the up-sampling or the clipping during the sharpness enhancement process.

### SUMMARY OF THE INVENTION

Accordingly, it is an aspect of the present general inventive concept to provide an apparatus and method for image sharpness enhancement which prevents signal distortion and creation of an objectionable image by adaptively adding a weighted diffusivity to an image signal.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing an apparatus to provide image sharpness enhancement, comprising a slope value calculator to set in an input video signal a window of a predetermined size with reference to a current pixel, and to calculate a slope value based on pixel values within the window, a gain calculator to calculate a gain corresponding to a magnitude of the slope value, a differential value calculator to calculate a differential value which is a difference between pixel values of the current pixel and other pixels within the window, a diffusivity calculator to calculate the diffusivity between the pixels corresponding to the magnitude of the differential value, a diffusivity summer to assign a predetermined weight to the diffusivities between the pixels and to calculate the sum of the diffusivities; and a pixel value converter to multiply the sum of the diffusivities by the gain and to add the multiplied result to the current pixel value. The apparatus to provide image sharpness enhancement may further comprise a multiplier to supply the value obtained by multiplying the sum of the diffusivities by the gain to the pixel value converter.

The gain calculator calculates a gain of 1 if the slope value is less than a predetermined threshold, and if the slope value is greater than or equal to the predetermined threshold, calculates a gain less than 1 so that the gain is decreased corresponding to the magnitude of the slope value. The diffusivity calculator divides into a low area, a middle area, and a high area according to the magnitude of the differential value, and calculates the diffusivity between the pixels for each area in a different ratio. The weight may be in a Gaussian shape.

The foregoing and/or other aspects and advantages of the present general inventive concept are also achieved by providing a method of image sharpness enhancement comprising setting in an input video signal a window of a predetermined size with reference to a current pixel, and calculating a slope value based on pixel values within the window, calculating a gain corresponding to a magnitude of the slope value, calculating a differential value which is a difference between pixel values of the current pixel and other pixels within the window, calculating the diffusivity between the pixels corresponding to the magnitude of the differential value, assigning a predetermined weight to the diffusivities between the pixels and calculating the sum of the diffusivities, and multiplying the sum of the diffusivities by the gain and adding the multiplied result to the current pixel value.

The operation of calculating the gain calculates a gain of 1 if the slope value is less than a predetermined threshold, and if the slope value is greater than or equal to the predetermined threshold, calculates a gain less than 1 so that the gain is decreased corresponding to the magnitude of the slope value. The operation of calculating the diffusivity between the pixels divides into a low area, a middle area, and a high area according to the magnitude of the differential value, and calculates the diffusivity between the pixels for each area in a different ratio. The weight may be in a Gaussian shape.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram showing an apparatus to provide image sharpness enhancement according to an embodiment of the preset general inventive concept;

FIG. 2 is a flowchart showing exemplary operations of a method of image sharpness enhancement according to an embodiment of the present general inventive concept;

FIGS. 3A and 3B are views showing examples of pixel value distributions;

FIG. 4 is a graph showing a relation between a slope value and a gain; and

FIG. 5 is a graph showing a relation between a pixel difference and diffusivity between pixels.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

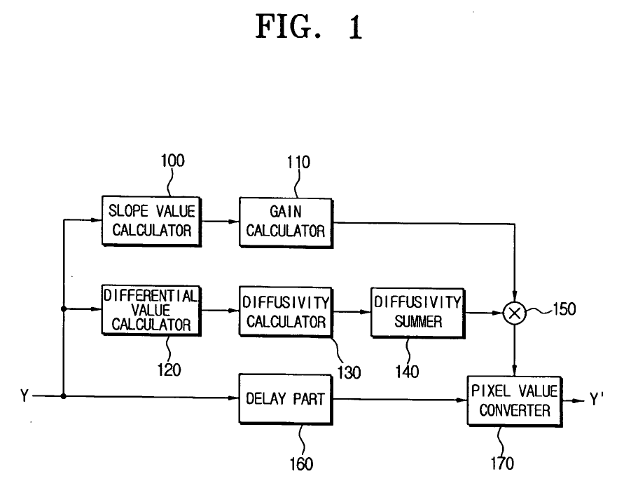

FIG. 1 is a block diagram showing an apparatus to provide image sharpness enhancement according to an embodiment of the present general inventive concept. Referring to FIG. 1, the apparatus to provide image sharpness enhancement comprises a slope value calculator 100, a gain calculator 110, a differential value calculator 120, a diffusivity calculator 130, a diffusivity amount summer 140, a multiplier 150, a delay part 160, and a pixel value converter 170.

The slope value calculator 100 can set in an input video signal a window of a predetermined size with reference to a current pixel, and calculate a slope value based on pixel values within the window. The gain calculator 110 calculates a gain corresponding to the magnitude of the slope value calculated by the slope value calculator 100. The differential value calculator 120 calculates a differential value, which is a difference between a pixel value of the current pixel of the input video signal and a pixel value of another pixel within the window. The diffusivity calculator 130 calculates the diffusivity between pixels, which corresponds to the magnitude of the differential value calculated by the differential value calculator 120. The diffusivity summer 140 assigns a predetermined weight to the diffusivities between pixels calculated by the diffusivity calculator 130 and calculates the sum of the diffusivities. The multiplier 150 multiplies the sum of the diffusivities calculated by the diffusivity summer 140 with the gain calculated by the gain value calculator 110, and supplies the multiplied value to the pixel value converter 170. The pixel value converter 170 adds the results of multiplying the diffusivity by the gain to the current pixel value and outputs the result. The delay part 160 delays the input video signal for the calculation-synchronization and supplies the delayed signal to the pixel value converter 170.

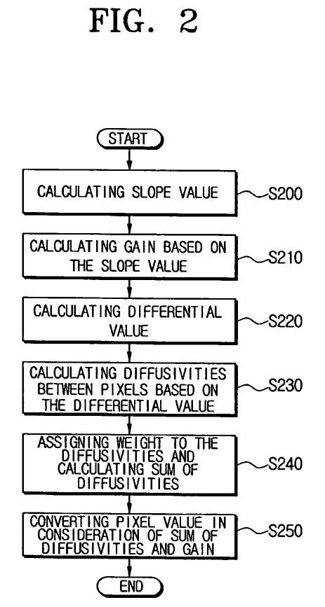

FIG. 2 is a flowchart showing exemplary operations of a method of image sharpness enhancement according to an embodiment of the present general inventive concept.

Referring to FIGS. 1 and 2, the slope value calculator 100 sets in an input video signal a window of a predetermined size with reference to a current pixel, and calculates a slope within the window (S200). The slope value may be acquired from a difference between pixel values of neighboring pixels within the window.

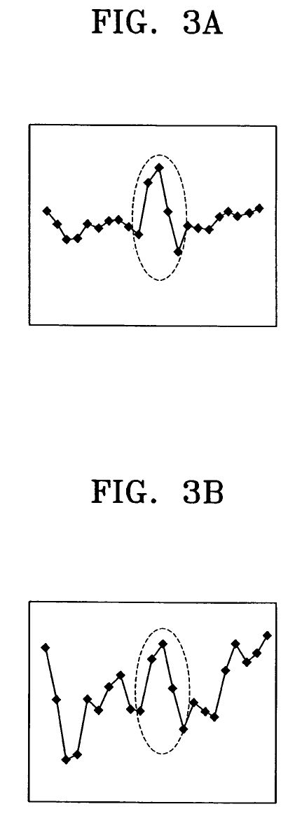

FIGS. 3A and 3B are views showing examples of distributions of pixels values. In FIGS. 3A and 3B, the x-axis (horizontal) represents pixel locations and the y-axis (vertical) represents a corresponding pixel value. The pixels within the dotted circles of FIGS. 3A and 3B have varying visual sensitivity depending on the area the pixels belong to, although the pixels have the same texture component. More specifically, although the pixels as shown in FIG. 3A have the same texture component as those of FIG. 3B, being in a softer area, the pixels are viewed more acutely than those of FIG. 3B. These visual characteristics have to be taken into consideration when improving the image sharpness. Therefore, it has to be determined which area the current pixel belongs to by using the slope value.

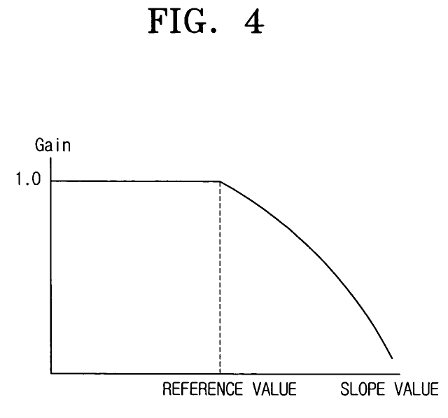

The gain value calculator 110 calculates a gain based on the slope value calculated by the slope value calculator 100 (S210). As shown in FIG. 4, with respect to the slope value smaller than a predetermined reference value, the gain is set to 1.0 to maintain the sharpness as it is. With respect to the slope value greater than or equal to the reference value, the gain is decreased to reduce the sharpness enhancement and subsequent generation of an objectionable image.

The differential value calculator 120 calculates a differential value between the current pixel of the input video signal and another pixel within the window (S220). The differential value is defined as a pixel difference between a pixel value of the current pixel and a pixel value of another pixel within the window. This is expressed by the following equation:
∇≡I_{N}−1 [Equation 1]
wherein I denotes a pixel value of a current pixel, and IN denotes a pixel value of another pixel within the window.

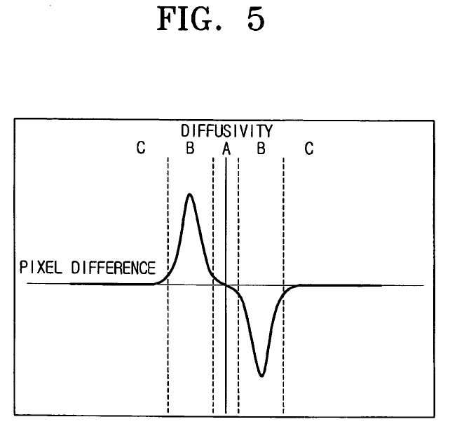

The diffusivity calculator 130 calculates the diffusivity between the pixels based on the differential value calculated by the differential value calculator 120 (S230). The diffusivity may be calculated by using a graph as shown in FIG. 5 which shows a relation between the pixel difference and the diffusivity. The pixel difference is divided into a low area A, a middle area B and a high area C according to the magnitude thereof. The diffusivity between pixels varies according to the divided area. That is, in the low area A, which is a soft area and therefore visually sensitive, even a slight increase in the pixel values causes the visibly objectionable image. Accordingly, in this area, it is preferred not to change the pixel value or if desired, increase the pixel value very slightly. The middle area B shows that the pixel difference is in an intermediate range, and typically includes the area having the texture component and the outline of an object. This area should emphasize the texture component and the outline by increasing the pixel value so as to improve the image sharpness. In the high area C, in which the pixel value is high, the texture component and the outline are already sufficiently emphasized in the original signal, and if more emphasized, there will occur a counter result such as overshoot or undershoot which is visibly objectionable. Accordingly, in the high area C, it is preferred not to change the pixel value, or if necessary, increase the pixel value very slightly.

The diffusivity summer 140 assigns a weight of Gaussian shape to the diffusivity between the pixels calculated by the diffusivity calculator 130 and calculates the sum of the diffusivities. This is expressed by the following equation:

$${S}_{C} = {\sum }_{i ∈ w} {w}_{i} \cdot c ( ∇ I ) \qquad [ Equation 2 ]$$

wherein W denotes a window, wᵢ denotes a weight of Gaussian shape, and c(∇I) denotes the diffusivity between the pixels. According to this method, not only the pixel near to the current pixel, but also any pixels within the window can be considered for sharpness enhancement.

The pixel value converter 170 converts the pixel value by multiplying the sum of the diffusivities, calculated by the diffusivity summer 140, by the gain calculated by the gain value calculator 110, and adding the multiplied value to the current pixel (S250). This is expressed by the following equation:
Y′=Y+S_{C}·G [Equation 3]
wherein Y′ denotes an output pixel value, Y denotes a current pixel value, S_{C} is a sum of diffusivities, and G denotes a gain.

By adaptively applying the weighted diffusivity to the input video in the manner disclosed in the above, the sharpness of image is improved, and especially improved in the soft area, so that creation of an objectionable image is prevented.

According to the present general inventive concept, by adaptively applying a weighted diffusivity to a video signal, image sharpness enhancement is achieved while a visibly objectionable image and signal distortion are prevented. Accordingly, the sharpness of the video signal is efficiently improved, so that a more vivid image quality can be obtained.

The present general inventive concept can be realized as a method, an apparatus, and a system. When the present general inventive concept is manifested in computer software, components of the present general inventive concept may be replaced with code segments that are necessary to perform the required action. Programs or code segments may be stored in media readable by a processor, and transmitted as computer data that is combined with carrier waves via a transmission media or a communication network.

The media readable by a processor include anything that can store and transmit information, such as, electronic circuits, semiconductor memory devices, ROM, flash memory, EEPROM, floppy discs, optical discs, hard discs, optical fiber, radio frequency (RF) networks, etc. The computer data also includes any data that can be transmitted via an electric network channel, optical fiber, air, electro-magnetic field, RF network, etc.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An apparatus to provide image sharpness enhancement comprising:
a slope value calculator to set in an input video signal a window of a predetermined size with reference to a current pixel, and to calculate a slope value based on pixel values within the window;
a gain calculator to calculate a gain corresponding to the magnitude of the slope value;
a differential value calculator to calculate a differential value which is a difference between pixel values of the current pixel and another pixels within the window;
a diffusivity calculator to calculate the diffusivity between the pixels corresponding to the magnitude of the differential value;
a diffusivity summer to assign a predetermined weight to the diffusivities between the pixels and calculate the sum of the diffusivities; and
a pixel value converter to multiply the sum of the diffusivities by the gain and to add the multiplied result to the current pixel value.

2. The apparatus to provide image sharpness enhancement of claim 1, further comprising a multiplier to supply the value obtained by multiplying the sum of the diffusivities by the gain to the pixel value converter.

3. The apparatus to provide image sharpness enhancement of claim 1, wherein the gain calculator calculates a gain of ‘1’ if the slope value is less than a predetermined threshold, and if the slope value is greater than or equal to the predetermined threshold, calculates a gain less than ‘1’ so that the gain is decreased corresponding to the magnitude of the slope value.

4. The apparatus to provide image sharpness enhancement of claim 1, wherein the diffusivity calculator divides into a low area, a middle area, and a high area according to the magnitude of the differential value, and calculates the diffusivity between the pixels for each area in a different ratio.

5. The apparatus to provide sharpness enhancement of claim 1, wherein the weight is in a Gaussian shape.

6. An apparatus to enhance image sharpness, comprising:
a first calculation unit to set in an input video signal a window of a predetermined size with reference to a current pixel, and to calculate a gain of pixel values within the window;
a differential value calculator to calculate a differential value representing a difference between pixel values of the current pixel and other pixels within the window;
a diffusivity calculator to calculate a diffusivity between the pixels corresponding to the magnitude of the differential value, assign a predetermined weight to the diffusivities between the pixels and calculate the sum of the diffusivities; and
a pixel value converter to multiply the sum of the diffusivities by the gain and to add the multiplied result to the current pixel value.

7. The apparatus of claim 6, wherein the pixel converter includes a multiplier to multiply the sum of the diffusivities by the gain.

8. The apparatus of claim 6, further comprising a delay unit to delay the input video signal for calculation-synchronization of the input video signal with the operations of the first calculation unit, the differential value calculator and the diffusivity calculator.

9. The apparatus of claim 6, wherein the first calculation unit calculates the gain of pixel values within the window based on a slope of pixel values within the window.

10. The apparatus of claim 9, wherein the gain calculator calculates a gain of ‘1’ if the slope value is less than a predetermined threshold, and if the slope value is greater than or equal to the predetermined threshold, calculates a gain less than ‘1’ so that the gain is decreased corresponding to the magnitude of the slope value.

11. The apparatus of claim 9, wherein the diffusivity calculator divides into a low area, a middle area, and a high area according to the magnitude of the differential value, and calculates the diffusivity between the pixels for each area in a different ratio.

12. The apparatus of claim 6, wherein the weight is in a Gaussian shape.

13. A method of image sharpness enhancement comprising:
setting in an input video signal a window of a predetermined size with reference to a current pixel, and calculating a slope value based on pixel values within the window;
calculating a gain corresponding to the magnitude of the slope value;
calculating a differential value which is a difference between pixel values of the current pixel and other pixels within the window;
calculating the diffusivity between the pixels corresponding to the magnitude of the differential value;
assigning a predetermined weight to the diffusivities between the pixels and calculating the sum of the diffusivities; and
multiplying the sum of the diffusivities by the gain and adding the multiplied result to the current pixel value.

14. The method of image sharpness enhancement of claim 13, wherein the operation of calculating the gain calculates a gain of 1 if the slope value is less than a predetermined threshold, and if the slope value is greater than or equal to the predetermined threshold, calculates a gain less than 1 so that the gain is decreased corresponding to the magnitude of the slope value.

15. The method of image sharpness enhancement of claim 13, wherein the operation of calculating the diffusivity between the pixels divides into a low area, a middle area, and a high area according to the magnitude of the differential value, and calculates the diffusivity between the pixels for each area in a different ratio.

16. The method of sharpness enhancement of claim 13, wherein the weight is in a Gaussian shape.

17. A computer readable storage medium containing a method of image sharpness enhancement comprising:
setting in an input video signal a window of a predetermined size with reference to a current pixel, and calculating a slope value based on pixel values within the window;
calculating a gain corresponding to a magnitude of the slope value;
calculating a differential value which is a difference between pixel values of the current pixel and other pixels within the window;
calculating a diffusivity between the pixels corresponding to the magnitude of the differential value;
assigning a predetermined weight to the diffusivities between the pixels and calculating a sum of the diffusivities; and
multiplying the sum of the diffusivities by the gain and adding the multiplied result to the current pixel value.

18. The computer readable storage medium of claim 17, wherein the operation of calculating the gain calculates a gain of 1 if the slope value is less than a predetermined threshold, and if the slope value is greater than or equal to the predetermined threshold, calculates a gain less than 1 so that the gain is decreased corresponding to the magnitude of the slope value.

19. The method for image sharpness enhancement of claim 17, wherein the operation of calculating the diffusivity between the pixels divides into a low area, a middle area, and a high area according to the magnitude of the differential value, and calculates the diffusivity between the pixels for each area in a different ratio.

20. The computer readable storage medium of claim 17, wherein the weight is in a Gaussian shape.
